(19) United States
(12) Patent Application Publication
(10) Pub. No.: US 2025/0170749 A1
(43) Pub. Date: May 29, 2025

(54) CONCRETE FOR 3D PRINTING OF WALLS AND OTHER ARCHITECTURAL APPLICATIONS

(71) Applicant: CEMENTOS ARGOS S.A., Medellín (CO)

(72) Inventors: Sandra Julieth GARCÍA, Medellín (CO); Héctor Leonardo ROMERO, Medellín (CO); Federico SALDARRIAGA, Medellín (CO)

(21) Appl. No.: 18/935,297

(22) Filed: Nov. 1, 2024

Related U.S. Application Data
(60) Provisional application No. 63/596,219, filed on Nov. 3, 2023.

(51) Int. Cl. B28B 1/00; B33Y 10/00; B33Y 70/10; C04B 14/28; C04B 16/06; C04B 22/14; C04B 24/02; C04B 24/04; C04B 24/12; C04B 24/16; C04B 24/20; C04B 24/38; C04B 103/00; C04B 103/10; C04B 103/20; C04B 103/30; C04B 103/56

(52) U.S. Cl. CPC B28B 1/001; B33Y 10/00; B33Y 70/10; C04B 14/28; C04B 16/0633; C04B 22/148; C04B 24/02; C04B 24/04; C04B 24/128; C04B 24/168; C04B 24/20; C04B 24/383; C04B 2103/0079; C04B 2103/10; C04B 2103/20; C04B 2103/30; C04B 2103/58

(57) ABSTRACT

The present development corresponds to a concrete composition for 3D printing comprising cementitious agent, polydisperse matrix, fine materials, plasticizer, concrete accelerator, rheology controller, concrete retarder and optionally concrete shrinkage controllers and/or supplementary cementitious materials (SCMs), wherein the cementitious agent has an addition between 0% and 10% and wherein the mixture between the cementitious, polydisperse matrix, fine materials, and SCMs has a Rosin-Rammler distribution parameter less than 1. The present development is also related to the use of the concrete composition for 3D printing of structural walls and other architectural elements with a mechanical strength greater than 30 MPa and a very high quality of the finished surface.

### TECHNICAL FIELD

The composition of the present development is related to the field of civil engineering. Specifically, to the technology of formulating concrete compositions for 3D (three-dimensional) printing at large scale walls and other architectural applications. It also encompasses the methods of preparation and uses of such concrete compositions.

### BACKGROUND OF THE INVENTION

One of the most significant technical challenges in the design of concrete compositions for 3D printing is achieving the right rheology or flow characteristics of the material. The concrete composition must be able to flow smoothly through the 3D printing nozzle while maintaining its shape and structural integrity as it sets. Achieving the right balance between viscosity, yield stress, and thixotropy is critical to ensuring that the printed structure does not collapse or deform during printing.

Particularly, the rheological behavior of the concrete mix is a critical factor in 3D printing. The mixture should have a suitable viscosity and flowability to ensure that it can be extruded accurately from the printer nozzle without clogging or segregating. In this sense, the concrete composition needs to be able to be extruded from the printer head, hold its shape, and cure quickly enough to support the next layer.

In 3D printing, the setting time (time required for the ink to harden and gain strength) should be long enough to allow the concrete to be printed, but not too long that it causes significant delays in the printing process. The rheological behavior affects the speed at which the printer head extrudes concrete, determining the final quality of the printed structure which may need to be optimized for each specific project.

Another challenge is ensuring that the printed structure has sufficient strength and durability. That is why traditional concrete mixes are usually not suitable for 3D printing due to their high viscosity, which can lead to cracking and other physical defects. The structure needs to be able to support its weight, as well as any additional loads that it may be subjected to, such as wind or seismic loads. The strength and durability of the printed concrete are essential for the structure's safety and longevity. In addition, the concrete composition must be able to resist cracking, erosion, and other forms of wear and tear.

Most current 3D printing systems are limited in terms of the size of the structures they can print. Particularly, concrete is prone to shrinkage as it dries, which can cause cracks and distortions in the printed structure, hence, some people control the shrinkage by adding suitable admixtures to the concrete mix.

However, developing larger-scale 3D printing systems and improving printing speeds will be crucial to making 3D printing a viable option for large-scale construction projects. Researchers are experimenting with adding various additives to improve the strength and durability of 3D-printed concrete, including fibers, nanoparticles, and admixtures.

Furthermore, the surface finish of the printed structure can be affected by a variety of factors, such as the quality of the printing material, printing speed, and printer settings. Achieving a high-quality surface finish can be challenging but is essential for the aesthetics and durability of the final product.

Sustainability and environmental impact are also critical factors to be considered when developing concrete compositions for 3D printing. Concrete is known to have a significant environmental impact due to its high carbon footprint. Therefore, sustainability is a crucial factor that needs to be taken into consideration when developing concrete compositions for 3D printing.

In addition, the cost of materials and equipment required for concrete 3D printing can also be a significant barrier to adoption. The high cost of 3D printers, as well as the cost of the specialized materials and additives required for the process, can make it difficult to achieve cost-effective solutions. In fact, the technology needs to be developed to allow large-scale printing of concrete structures. This requires careful consideration of the printing process, material supply, and structural design.

Accordingly, selecting the right combination of components and additives in a concrete composition is critical for the success of viable 3D-printed concrete structures. The material should have good rheological properties to enable proper extrusion and should also have adequate strength and durability properties for the intended use. Thus, the mixture design of the concrete composition should be carefully optimized to achieve the desired printability and properties, having a good balance of workability, strength, and setting time to enable efficient printing.

In summary, there are many technical challenges involved in developing suitable concrete compositions for 3D printing. A lot of research is being conducted to overcome these challenges and to develop reliable and efficient 3D printing processes for concrete structures.

As an example, patent application WO2020/187742 discloses a composition of dry mineral binder for 3D printing of moldings that comprises 10% to 50 of cement, 45 wt. % to 85 wt. % of mineral fillers with a particle size ranging from 0.1 μm to 32 mm, 20% to 40 wt. % of fine fillers with a particle size smaller than 0.125 mm, 0% to 10 wt. % of hydraulic or pozzolanic latent binder based on metakaolin and/or silica fume, 0.1% to 2 wt. % of an accelerator based on aluminum sulfate, 0.02% wt. % to 5 wt. % of a superplasticizer based on a polycarboxylate ether, 0.01% to 5 wt. % of a rheology auxiliary, 0.1% to 5 wt. % of calcium sulfoaluminate, 0.01% to 1.5 wt. % of defoamer, and optionally, 0% to 10 wt. % of additives wherein, said composition requires the combination of calcium sulfoaluminate and a superabsorbent rheology aid in the presence of an additional accelerant such as aluminum sulfate.

Similarly, patent CN104310918 discloses a cement-based composite material for 3D printing technology, and a method for its preparation and use. The material comprises (by weight) cement in the range of 33% to 40%, inorganic powder in the range of 0% to 8%, tailings sands in the range of 32% to 38%, polymer in the range of 2.5% to 3.0%, composite coagulant in the range of 0.2% to 1%, volumetric stabilizer in the range of 1% to 2%, thixotropic agent in the range of 0.5% to 1.5%, water reducer in the range of 0.1% to 0.5%, and water in the range of 16.7% to 20%.

In turn, patent CN113309290 discloses an ultra-high ductility cementitious composite material comprising: 10 to 30 parts cement; 30 to 55 parts fly ash; 0.01 to 5 parts silica fume; 15 to 30 parts sand; 0.1 to 10 parts nickel slag sand; 0.1 to 10 parts limestone powder; 8 to 25 parts water; 0.05 to 0.5 parts polycarboxylic acid high-performance water-reducing agent; 0.5 to 2 parts polyethylene fiber; 0 to 0.02 parts cellulose ether; 0 to 0.01 parts hot-melt adhesive; and 0 to 0.1 parts nano-silica. The nickel slag sand has a particle size between 0.16 and 5 mm and is air-cooled or water-cooled nickel slag. The powdered limestone has a calcium carbonate content of ≥90% and a specific surface area of ≥300 kg/m².

Finally, patent CN105731942 discloses a cementitious composite material for 3D printing comprising, on a weight percent basis: composite cementitious material 19-25%; shrinkage inhibitor 0.2-0.6%; anti-carbonation agent 1-2%; aggregates 57-66%; fiber reinforcement 0.3-1.1%; alkali-free fast-setting liquid agent 0.9-1.8%; retarding agent 0.8-1.7%; thickening agent 0.02-2%; plasticizer 0.2-0.4%; defoamer 0.04-0.09%; water reducer 0.04-0.2%; and water 5-14%. The antifoaming agent is at least one of dimethylsilicone oil, soybean oil, corn oil, polyoxyethylene glycol, and high-carbon alcohol. The anticarbonating agent is a chlorine-based emulsion and/or a benzine emulsion. The alkali-free fast-setting liquid agent comprises polymeric aluminum sulfate (35-55% by weight), magnesium sulfate (5-25% by weight of said polymeric aluminum sulfate), alcoholic amine (15-30% by weight of said polymeric aluminum sulfate), inorganic acid (0-5%), stabilizer (0-5%), and the remainder is water.

However, it appears that the concrete compositions developed so far are aimed at solving some of the specific challenges required for 3D printing and new alternatives are still welcome. In this sense, the inventors identified the need to develop concrete compositions that allow the 3D printing of structural walls and architectural elements that require high mechanical strength and very high quality of the finished surface.

### BRIEF DESCRIPTION

The present development is directed to a concrete composition for 3D printing comprising, by weight, cementitious agent between 20% w/w to 40% w/w; polydisperse matrix between 50% w/w to 70% w/w; fine materials between 0% w/w to 20% w/w; plasticizer between 0.05% w/w to 5% w/w; concrete accelerator between 1% w/w to 9% w/w; rheology controller between 0.04% w/w to 0.3% w/w; concrete retarder between 0.1% w/w to 3% w/w; and optionally concrete shrinkage controllers between 0 w/w to 1% w/w and/or supplementary cementitious materials (SCMs) between 5% w/w to 20% w/w; wherein the cementitious agent have an addition between 0% and 10%; and wherein the mixture between the cementitious, polydisperse matrix, fine materials, and SCMs has a Rosin-Rammler distribution parameter of less than 1.

In addition, the present development is also related to the use of the concrete composition for 3D printing, for example of structural walls, furniture, prefabricated elements, and other architectural elements under continuous constructions with a mechanical strength greater than 30 MPa.

### BRIEF DESCRIPTION OF THE DRAWINGS

FIG. 1. Open time (flowability) behavior for compositions A to F, H, I, J, and K.

FIG. 2. Yield stress results in compositions A, B, and C.

FIG. 3. Compressive strength for composition A at 1, 3, 7, and 28 days.

FIG. 4A Showcases a structure printed with composition A using a robotic arm, reaching a maximum height of 38 cm.

FIG. 4B Showcases a structure printed with composition A using a robotic arm, reaching a maximum height of 38 cm.

FIG. 4C Also created with composition A, measures 1 m×0.8 m and was produced with a small-configured gantry.

FIG. 4D Printed with composition A using an industrial gantry, has dimensions of 3 m×0.3 m. Continuous cracks are observed, likely due to the scale of the designs and the type of mixture used, while ensuring both stackability and printability of the element.

FIG. 4E Printed with composition J, represents a model house covering 61 m² and was produced using an industrial gantry, where no cracking is observed. The printability properties, texture, and finishes of the composition were evaluated at a larger scale.

FIG. 4F Shows the print of a textured column structure, produced using the gantry system. The material exhibited excellent plastic and mechanical performance and provides a high-quality final finish.

FIG. 4G Illustrates the ink's adaptability to variations in nozzle specifications. The material maintains consistent performance in both plasticity and mechanical properties, ensuring reliable extrusion and structural integrity even with adjustments to the nozzle configuration.

FIG. 4H Presents a component printed with a robotic arm, showcasing a smooth and precise finish. The element, with dimensions of 80 cm×60 cm, demonstrates excellent surface quality and geometric accuracy, highlighting the versatility and precision achievable in smaller-scale 3D printing applications.

### DETAILED DESCRIPTION

Terms used in the following description have the meanings normally given to them in the technical field unless this description or the context clearly indicates otherwise. Where appropriate, terms used in the singular form shall also include the plural form. Unless otherwise indicated, by either contextual implications or customary practices, all parts and percentages in the present description are based on weight. The term “approximately” means variations of 55% of the defined value.

The present development corresponds to a concrete composition for 3D printing comprising a cementitious agent, a polydisperse matrix, fine materials, supplementary cementitious materials (SCMs), at least one plasticizer, at least one concrete accelerator, at least one rheology controller, and at least one concrete retarder, and optionally a retraction controller. Wherein the cementitious agent has an addition between 0% and 10%. Wherein the mixture between the cementitious agent, polydisperse matrix, fine materials, and SCMs has a Rosin-Rammler distribution parameter of less than 1.

### The Rosin-Rammler Distribution Parameter

The Rosin-Rammler distribution is a statistical distribution parameter commonly used to describe the particle size distribution of a material. In the context of concrete compositions for 3D printing, the Rosin-Rammler distribution can be used to describe the distribution of particle sizes in the aggregates that make up the concrete mix.

The Rosin-Rammler distribution parameter is defined by two parameters: the characteristic size (also called the “scale parameter”) and the spread parameter. The characteristic size represents the size below which a certain fraction of the particles falls, while the spread parameter determines the spread or width of the distribution.

The characteristic size (kᵣᵣ) is the size at which the cumulative weight of particles in the sample is smaller than that size. It is sometimes referred to as the “median size” or the “geometric mean size.” The characteristic size is a measure of the average particle size in the sample, but it should not be interpreted as typical or representative particle size, as it does not account for the entire particle size distribution.

The spread parameter (m) is a measure of the width of the particle size distribution. It describes the range of particle sizes in the sample and is related to the standard deviation of the distribution. A small value of m indicates a narrow distribution of particle sizes, while a large value of m indicates a wide distribution.

Together, the characteristic size and the spread parameter of the Rosin-Rammler distribution can provide useful information about the particle size distribution of a sample. Invertors found out that by controlling these parameters, they can make informed decisions about the appropriate particle sizes to use in the different applications, in which the particle size distribution affects the properties of the final product.

In concrete compositions for 3D printing, the Rosin-Rammler distribution parameter is important because it can affect the rheological properties of the mix. The rheological properties can impact the printing quality and final properties of the printed structure. By selecting the right combination of components and additives in the concrete composition and controlling the particle size distribution between the aggregates (particularly cementitious agent, polydisperse matrix, fine materials, and SCMs) using the Rosin-Rammler distribution, the inventors optimized the rheological properties of the concrete composition. Said optimization allows more consistent printing and better structural properties in the final product improving the workability, printability, and mechanical properties.

The Rosin-Rammler distribution equation takes the form:

$$y = 100 ⋆ ( 1 - exp {( \frac{x}{{k}_{rr}} )}^{m} ) \qquad ( Equation l )$$

wherein:
y is the cumulative fraction of particles with a diameter less than or equal to x;
x is the particle diameter;
kᵣᵣ is the characteristic median diameter of the particles;
m is the Rosin-Rammler distribution parameter, determining the slope of the curve.

A value in the distribution parameter m equal to 1 suggests a single size distribution, and when the values of m<1, the tendency is to have a wide range of sizes. This suggests better rheological management of the concrete composition, for example, when the parameter is closer to one, the flowability of the mixture is compromised. The flowability is compromised when the parameter approaches 1, as this can lead to an increase in viscosity, complicating the transport of the mixture through the extrusion and pumping systems. Furthermore, this can negatively impact both the finishing and stability of the mixture.

The above equation is used in the design of the mesh in the composition production, wherein different components particles size may vary between certain ranges/percentages in order to prepare compositions at larger scales. The preceding equation was used to determine the percentage of particles retained on each mesh, thereby establishing acceptable value ranges that ensure the reproducibility of designs on an industrial scale.

### Cementitious Agent

In a concrete composition for 3D printing, the cementitious agent serves as the binding material that holds the aggregate particles together to form a solid structure. The cementitious agent reacts with water to form a chemical bond, called hydration, which causes the mixture to solidify and harden over time. The type of cementitious agent used in a concrete composition for 3D printing can have a significant impact on the properties of the final product.

Overall, the cementitious agent plays a critical role in the success of 3D printing with concrete, as it determines the strength, durability, and workability of the final product. For example, Portland cement is a commonly used cementitious agent that provides strength and durability to the concrete, while fly ash and silica fume can improve the workability and reduce the permeability of the mixture. Nevertheless, in the context of the present development, the use of structural cement allows lower dosage percentages in the mix to achieve mechanical strengths in structural applications. Additionally, supplementary cementitious material can be incorporated to obtain better performance in terms of durability.

Accordingly, the present development corresponds to a concrete composition for 3D printing comprising a cementitious agent selected from structural cement.

For the purposes of the present development, the cementitious agent is in the range between 20% w/w to 40% w/w of the whole concrete composition; preferably between 20% w/w to 35% w/w; or more preferably between 20% w/w to 30% w/w.

In addition, the cementitious agent has an addition between 0% and 10% and preferably the cementitious agent does not have an addition of more than 5%.

### Polydisperse Matrix

A polydisperse matrix in a concrete composition for 3D printing refers to a mixture of aggregate particles that have a range of sizes, rather than a single, uniform size. The function of a polydisperse matrix in concrete for 3D printing is to improve the workability and printability of the material, as well as to enhance the mechanical properties of the final product.

When a polydisperse matrix is used in 3D printing with a cementitious agent, the larger aggregate particles help to improve the overall strength and stiffness of the printed structure. Meanwhile, the smaller particles fill in the gaps between the larger particles and help to improve the workability of the mixture, making it easier to extrude and shape.

In addition, a polydisperse matrix can help to prevent cracking and shrinkage of the printed structure by reducing the amount of stress concentration points within the material. The varying sizes of the aggregate particles help to distribute stress more evenly throughout the material, reducing the risk of cracking or failure. Therefore, the polydisperse matrix can improve a concrete composition for 3D printing by improving flowability, enhancing mechanical properties and improving adhesion

Overall, a polydisperse matrix can be a valuable addition to a concrete composition for 3D printing, helping to improve the workability, printability, and durability of the printed structure and mechanical properties of the material making it better suited for use in construction applications such as structural walls, furniture, other architectural elements, and/or prefabricated elements, under continuous constructions.

For the purposes of the present development, the polydisperse matrix is selected from calcareous aggregates, siliceous aggregates, recycled aggregates, and mixtures thereof.

Furthermore, the polydisperse matrix in the concrete composition of the present development is in the range between 45% w/w to 80% w/w; between 45% w/w to 70% w/w; between 50% w/w to 65% w/w; or preferably between 55% w/w to 65% w/w. Wherein the particle size of the polydisperse matrix is below 15 mm, between 0.1 mm and 12 mm; preferably between 0.1 mm and 8 mm; or more preferably between 0.1 mm and 4 mm.

### Fine Materials

Fine materials are an important component of a concrete composition for 3D printing. The main function of fine materials is to improve the flowability and workability of the concrete mix, which is crucial for achieving a smooth and even printing process.

Furthermore, fine materials help to fill the gaps between the larger polydisperse matrix, which results in a more homogeneous mix. This makes it easier for the concrete composition to flow through the printer nozzle and be deposited in the desired shape. The presence of fine materials also improves the adhesion between the layers of the printed object, which is crucial for ensuring its structural integrity.

Fine materials can also improve the durability of the printed object since they help to reduce the porosity of the concrete composition and improve its resistance to water and other environmental factors. This is done by holding the larger aggregates in place and providing the structure with its compressive strength. Overall, the addition of fine materials to a concrete mix for 3D printing helps to create a mix with improved flowability, workability, and mechanical properties, which is essential for producing high-quality 3D printed concrete structures. For the present development the fine materials are selected from carbonate-based materials including calcium carbonate, silica fume, ash, slag, and mixtures thereof.

In the present development, fine materials are typically added to the concrete composition in smaller quantities than the polydisperse matrix. The proportion of fine materials in the mix can vary depending on the desired properties of the final product, but for the purposes of the present development it is usually in the range of 0% w/w to 20% w/w; preferably in the range of 10% w/w to 20% w/w; or preferably in the range of 5% w/w to 15% w/w of the total aggregate quantities.

Polydisperse matrix and fine materials are both components of 3D printed concrete, but they differ in their particle size distribution, nature of the particles, and their roles in the composition. Polydisperse matrix typically contains particles that are much greater than the fine materials and may have different shapes and chemical properties. In contrast, fine materials are typically smaller in size than the polydisperse matrix used in a concrete composition, and they fill in the gaps between the aggregates, creating a more cohesive mix.

Thus, the fine materials of the present development the particle size of the fine materials is between 1 μm to 150 μm; preferably between 1 μm to 50 μm; more between 1 μm to 5 μm.

### Supplementary Cementitious Materials (SCMs)

Supplementary cementitious materials (SCMs) are the materials used as partial cementitious replacements to lower costs of the use of clinker or improve the properties of end products, especially as regards performance and properties. In the context of the present development, SCMs are used to improve the printability of the concrete composition, as well as its durability, strength, and other important characteristics such as the resistance to degradation due to multiple mechanisms. Moreover, SCMs also help reduce the environmental impact of the concrete composition production process by substituting part of the cementitious agent content with waste materials or industrial byproducts that would otherwise be disposed in landfills.

In the present development, SCMs are optional. SCMs are selected from calcined clay, slag, fly ash, silica fume and mixtures thereof. Usually, for the purposes of the present development, SCMs are between 0 and 50% w/w, below 50%, below 30% w/w, in the range of 5% w/w to 20% w/w; or in the range of 5% w/w to 10% w/w; or in the range of 10% w/w to 20% w/w; or in the range of 5% w/w to 15% w/w; or in the range of 10% w/w to 15% w/w. The particle size of the SCMs is less than 150 μm; or in the range of 1 μm to 150 μm; or in the range of 1 μm to 100 μm; or in the range of 1 μm to 80 μm; or in the range of 1 μm to 50 μm.

### Plasticizers

In concrete 3D printing, plasticizers are often added to the concrete composition to improve its workability and flowability. A plasticizer is a chemical additive that is used to reduce the water content of a concrete while maintaining its workability. This is important for concrete 3D printing because the composition needs to be fluid enough to be extruded through the printer's nozzle but also strong enough to maintain its shape once it has been deposited.

Plasticizers work by adsorbing onto the surface of the particles of the cementitious agent, polydisperse matrix, fine materials, and SCMs. The adsorption reduces the inter-particle attractive forces and allows the particles to move more freely within the mix. This results in a more fluid composition that can be extruded more easily. For the concrete composition, the plasticizer is in the range of 0.05% w/w to 3% w/w; more preferably in the range of 0.05% w/w to 1.5% w/w; more preferably in the range of 0.1% w/w to 0.5% w/w.

There are many different types of plasticizers available for use in the context of the concrete composition of the present development, each with its own set of properties and advantages. Particularly, for the purpose of the present concrete composition the plasticizers are selected from polycarboxylate, lignosulfonates, naphthalene, melanins (such as sulfonated melamine), and mixtures thereof.

### Concrete Accelerators

On the other hand, accelerators are added to the concrete composition of the present development to speed up the setting and hardening process of the concrete. An accelerator is a chemical additive that is used to reduce the setting time of concrete, allowing it to gain strength more quickly. Particularly, in 3D printing, where a quick setting time is desirable to prevent the collapse of the printed structure, accelerators play a crucial role in ensuring that the concrete hardens rapidly enough to maintain its shape.

Accelerators work by increasing the rate of chemical reactions that take place within the concrete composition. For the present development, the concrete accelerators are selected from aluminum sulfate, organic and inorganic salts such as oxides, chlorides, bromides, fluorides, nitrites and nitrates, carbonates, thiocyanates, sulfates, thiosulfates, perchlorates, silicates, aluminates, aluminum sulfate, and mixtures thereof. The concrete accelerators react with the cementitious agent in the composition to produce more heat and accelerate the hydration process.

It is worth noting that while accelerators can be very effective in reducing the setting time of concrete, they can also have some downsides. For example, adding excess amounts of accelerator can lead to a decrease in the ultimate strength of the concrete, so it is important to use them judiciously. Consequently, in the context of the present concrete composition, the concrete accelerators are in the range of more than 0.4% w/w, between 0.5% w/w to 9% w/w; preferably between 1% w/w to 3% w/w; or more preferably between 1% w/w to 2% w/w.

### Concrete Retarders

In contrast to accelerators, concrete retarders are used to slow down the setting time of the concrete composition. Therefore, a retarder is a chemical additive that is used to extend the setting time of concrete, allowing it to remain workable for a longer period. For the purposes of the present development, the concrete retarders are selected from polysaccharides or glycols and mixtures thereof.

Retarders work by delaying the hydration reaction that occurs between the cement and water in the composition. This is useful in 3D printing applications where longer printing times are required, or where the environment may be hotter than optimal and cause the concrete to set too quickly. By slowing down the setting time of the mix, retarders can also help to reduce the risk of cracking and shrinkage in the printed structure. This is because concrete is given more time to cure and develop its strength before it begins to set.

Also, it is worth noting that using too much retarder can have negative effects on the ultimate strength of the concrete, so it is important to use them in moderation. Accordingly, in the context of the present invention the concrete retarders are in the range between 0.1% w/w to 3% w/w; preferably between 1% w/w to 1.5% w/w; or more preferably between 0.1% w/w to 1% w/w.

### Rheology Controllers

Rheology controllers are used to adjust the flow properties of the concrete mix to ensure that it can be extruded smoothly and accurately through the printer's nozzle. For the purposes of the present development, rheology controllers are chemical additives that are added to the concrete mix to modify its viscosity and flow properties. They work by interacting with the cement particles and altering the way they interact with each other, which can have a significant impact on the mix's overall flow properties.

There are many different types of rheology controllers that can be used in concrete 3D printing, including various polymers and surfactants. The choice of rheology controller will depend on the specific requirements of the mix and the printing process. However, in the present concrete composition, the rheology controllers are selected from medium molecular weight cellulose, cellulose ether, hydroxymethylethylcellulose (HEMC), hydroxypropyl methylcellulose (HPMC), and mixtures thereof.

The main function of rheology controller in the concrete composition for 3D printing of the present development is to adjust the mix's viscosity and flow properties to ensure that it can be extruded smoothly and accurately through the printer's nozzle. This is crucial for achieving precise and accurate prints with minimal defects or errors, therefore, the amount of rheology controllers in the composition must also be selected with great care. Indeed, the rheology controllers in the concrete composition for 3D printing of the present development are below 3% w/w, in the range of 0.01% w/w to 0.3% w/w; more preferably in the range of 0.01% w/w to 0.15% w/w; more preferably in the range of 0.01% w/w to 0.1% w/w.

By controlling the rheology of the concrete composition, the rheology controller can also help to prevent issues such as clogging of the printer's nozzle or the formation of air bubbles within the printed structure, which can compromise its structural integrity.

### Other Components

Plastic shrinkage cracking in concrete typically occurs within the first few hours after pouring of 3D printing, before the concrete gains significant strength. These cracks mar the surface, causing an uneven and unappealing appearance. More critically, they create vulnerabilities through which aggressive substances can infiltrate the concrete, accelerating other forms of deterioration. This compromises the overall performance, serviceability, durability, and aesthetic appeal of concrete structures. Effective control of plastic shrinkage cracking is therefore crucial for constructing durable, long-lasting structures with minimized life-cycle costs.

One of the main reasons for plastic shrinkage cracking is the evaporation-induced loss of water, which creates tensile shrinkage stress when concrete is sufficiently constrained.

When the rate of water evaporation surpasses the rate at which bleed water replenishes the surface, negative capillary pressures develop, causing volume changes in the concrete. This leads to the formation of tensile stresses within the paste due to these negative pressures and the concrete's strength development. Cracks appear when these tensile stresses exceed the concrete's tensile strength.

In addition, the concrete composition for 3D printing of the present development optionally comprises concrete shrinkage controllers. The concrete shrinkage controllers can be both chemical and/or physical, or a combination of both. The use of concrete shrinkage controllers in the composition promotes tensile and flexural strength, which is important in applications where the printed structure will be subjected to loads and stresses, as it helps to prevent the formation of cracks and fissures, increasing the useful life of the construction. The concrete shrinkage controllers are in the composition between 0 and 3% w/w, 0 and 1% w/w, less than 2% w/w, preferably approximately 0.4% w/w.

The concrete shrinkage controllers that are physical include fibers, that include but are not limited to glass fibers, nylon fibers, polyester fibers, polyolefin fibers, carbon fibers, flexible metallic fibers, polypropylene fibers, or other natural fibers and mixtures thereof. Wherein the size of the fibers is between 1 mm to 25 mm, between 1 mm to 20 mm; or is between 1 mm to 15 mm; or between 1 mm to 12 mm; or between 2 mm to 15 mm; or between 2 mm to 12 mm; or preferably between 6 mm and 19 mm. The concrete shrinkage controllers that are chemical include high-density polyethylene, polyvinyl alcohol, cellulose, and superabsorbent polymers (SAPs), calcium sulphoaluminate cements (CSA), lithium nitrate, sodium carbonate and naphthalene (shrinkage and superplasticizer), and mixtures thereof.

The use of concrete shrinkage controllers helps with water retention to control cracking as they act as reinforcements and prevent cracks from propagating rapidly, maintaining the integrity of the structure and minimizing volumetric changes. They generate a reduction in drying shrinkage and can improve durability.

### Characterization of the Concrete Composition

The concrete composition for 3D printing of the present development presents better consistency, workability, and processability. Due to the combination of its components with which wet mixes are obtained with a fluidity between 140 mm and 180 mm, yield stresses lower than 2000 Pa. In addition, the cured composition makes it possible to obtain materials with a compressive strength greater than 30 MPa.

### Preparation of Concrete Compositions

The preparation of the concrete compositions in the present invention can be carried out using any methodologies widely known in the field, as well as those that may emerge in the future. In essence, each component of the composition is sequentially mixed until a homogeneous mixture is achieved.

### Application and Uses

The concrete for 3D printing is useful in the production of architectural elements. Among the possible architectural elements are included, but not limited to, walls, buildings, engineering structures, molds and forms, art, craft, and visual displays, furniture for indoor and outdoor use.

A method for using a concrete composition for 3D printing comprises: preparing a composition, filling the pump system with said composition, pumping said composition through the printer nozzle, monitoring and adjustments, and post-operation.

The step of preparing the composition comprise mixing thoroughly a cementitious agent, a polydisperse matrix, fine materials, at least one plasticizer, at least one concrete accelerator, at least one rheology controller, at least one concrete retarder as described above, with water. Particularly, preparing a concrete composition for 3D printing comprising: a cementitious agent between 20% w/w to 40% w/w; polydisperse matrix between 50% w/w to 70% w/w; fine materials between 0% w/w to 20% w/w; plasticizer between 0.05% w/w to 3% w/w; concrete accelerator between 0.5% w/w to 9% w/w; rheology controller between 0.04% w/w to 0.3% w/w; and concrete retarder between 0.1% w/w to 3% w/w; wherein the cementitious agent has an addition between 0% and 10%; and wherein the mixture between the cementitious, polydisperse matrix, fine materials have a Rosin-Rammler distribution parameter of less than 1. It is necessary to ensure the composition is mixed thoroughly to achieve the desired consistency for pumping. Composition's viscosity and flowability can be adjusted in order to ensure it can be pumped without clogging or segregation. Optionally the preparation of the concrete composition includes adding at least one concrete shrinkage controller, preferably between 0% to 1% w/w.

Regarding the filling of the pump system, the composition prepared on the previous step is poured into the hopper or mixing chamber in order to fill the hose. To ensure a continuous flow towards the printer nozzle, the material flow rate should match the 3D printer's deposition speed to maintain a uniform layer thickness during printing.

If necessary, continuous monitoring of the pump pressure, composition mix consistency, and flow rate should be controlled to avoid interruptions or material defects. By following these steps, a skilled operator can ensure the smooth operation of pumping a composition for 3D printing in construction applications or in different types of printed elements.

The present development will be presented in detail through the following examples, which are provided for illustrative purposes only and are not intended to limit its scope.

### EXAMPLES

### Example 1: Preparation of Concrete Compositions Samples a to F, H, I, J, and K

As mentioned previously, the preparation of the concrete compositions is carried out by any of the techniques known in the field. However, the following options for mixing the components are suggested:
Continuous mixer: Determining the flow rate (m³) of the mixing water and the weight (kg) of the dry materials in such a way as to ensure an adequate consistency and a ratio of 13.5%+/−0.5% according to the technical specification.
Batch mixer: Be sure to use clean containers whenever you are going to start mixing. Add the recommended amount of water in a container. Slowly dose the powder until the defined amount is reached. Add more water during the mixing time, if necessary, without exceeding the recommended amount of water.

Additionally for the application of concrete compounding it is important that pumping and printing are executed continuously. The printing speed must be optimized between the mixer, pump, hose length, and printhead used.

Finally, for the cleaning of the equipment used, it is recommended to clean all tools and equipment immediately after use with sufficient water since hardened material can only be removed mechanically.

For purposes of the present invention several compositions were prepared, using the following components:
Cementitious agent: structural cement;
Fine material
   C90: calcium carbonate;
   BC15: calcium carbonate;
Polydisperse matrix:
   Sand N2: limestone aggregates;
   Sand C12: limestone aggregates;
   Sand N3: limestone aggregates;
Plasticizer:
   Sika Viscocrete™: polycarboxylates;
   AGP: naphthalene sulfonates;
   Melapret™: melamine;
Concrete accelerator:
   Sigunit 49AF: aluminum sulfate;
   Sigunit 49AF Mod: aluminium sufate+carbonates;
Rheology controller:
   Ultragel A: hydroxypropyl methyl cellulose;
   Ingrentia TA-27: methylhydroxypropyl cellulose;
Concrete retarder:
   Plastiment: amine+polysaccharides;
   Sika tard E™: methyl isothiazole+polysaccharides.
Concrete shrinkage controller:
   Sika Fiber: Polypropylene fibers of approximately 6 mm;
   Intraplast: sodium carbonate and naphthalene.

TABLE 1
Concrete composition A

| Component | | % w/w |
|---|---|---|
| Cementitious agent | Structural cement | 26.53 |
| Fine materials | C90 | 13.13 |
| Polydisperse matrix | Sand (N2) | 59.38 |
| Plasticizer | Sika viscocrete | 0.08 |
| Concrete accelerator | Sigunit 49AF Mod/Sigunit 49AF | 0.10/0.60 |
| Rheology controller | Ultragel A | 0.04 |
| Concrete retarder | Plastiment | 0.14 |

* For the characterization of the concrete compositions 13.0% water was added.
** Rosin-Rammler distribution parameter 0.74.

TABLE 2
Concrete composition B

| Component | | % w/w |
|---|---|---|
| Cementitious agent | Structural cement | 26.53 |
| Fine materials | C90 | 0 |
| Polydisperse matrix | Sand (C12) | 59.38 |
| Plasticizer | Sika viscocrete | 0.10 |
| Concrete accelerator | Sigunit 49AF | 0.90 |
| Rheology controller | Ingrentia TA-27 | 0.04 |
| Concrete retarder | Sika tard E | 0.14 |

* For the characterization of the concrete compositions 13.0% water was added.
** Rosin-Rammler distribution parameter 0.87.

TABLE 3
Concrete composition C

| Component | | % w/w |
|---|---|---|
| Cementitious agent | Structural cement | 26.53 |
| Fine materials | BC50 | 13.13 |
| polydisperse matrix | Sand (N2) | 59.38 |
| Plasticizer | Sika viscocrete | 0.08 |
| Concrete accelerator | Sigunit 49AF Mod/Sigunit 49AF | 0.10/0.60 |
| Rheology controller | Ultragel A | 0.04 |
| Concrete retarder | Plastiment | 0.14 |

* For the characterization of the concrete compositions 12.95% water was added
** Rosin-Rammler distribution parameter 0.74.

TABLE 4
Concrete composition D

| Component | | % w/w |
|---|---|---|
| Cementitious agent | Structural cement | 22.00 |
| Fine materials | C90 | 0 |
| polydisperse matrix | Sand (N3) | 77.12 |
| Plasticizer | Sika viscocrete | 0.19 |
| Concrete accelerator | Sigunit 49AF | 0.60 |
| Rheology controller | Ultragel A | 0.04 |
| Concrete retarder | Plastiment | 0.05 |

* For the characterization of the concrete compositions 12.5% water was added.
** Rosin-Rammler distribution parameter 0.70.

TABLE 5
Concrete composition E

| Component | | % w/w |
|---|---|---|
| Cementitious agent | Structural cement | 26.53 |
| Fine materials | C90 | 13.13 |
| polydisperse matrix | Sand (N2) | 59.52 |
| Plasticizer | AGP | 0.25 |
| Concrete accelerator | Calcium formate | 0.40 |
| Rheology controller | Ingrentia TA-27 | 0.07 |
| Concrete retarder | Sika tard E | 0.10 |

* For the characterization of the concrete compositions 12.8% water was added.
** Rosin-Rammler distribution parameter 0.74.

TABLE 6
Concrete composition F

| Component | | % w/w |
|---|---|---|
| Cementitious agent | Structural cement | 26.53 |
| Fine materials | C90 | 13.13 |
| polydisperse matrix | Sand (C12) | 59.65 |
| Plasticizer | Melapret | 0.15 |
| Concrete accelerator | Calcium formate | 0.40 |
| Rheology controller | Ingrentia TA-27 | 0.07 |
| Retarder concrete | Sika tard E | 0.07 |

* For the characterization of the concrete compositions 13.0% water was added.
** Rosin-Rammler distribution parameter 0.87.

TABLE 7
Concrete composition H

| Component | | % w/w |
|---|---|---|
| Cementitious agent | Structural cement | 26.53 |
| Fine materials | C90 | 13.1 |
| polydisperse matrix | Sand (N2) | 59.41 |
| Plasticizer | Sika viscocrete | 0.08 |
| Concrete accelerator | Sigunit 49AF Mod/Sigunit 49AF | 0.10/0.60 |
| Rheology controller | Ultragel A | 0.04 |
| Retarder concrete | Plastiment | 0.14 |

* For the characterization of the concrete compositions 13.20% water was added.
** Rosin-Rammler distribution parameter 0.74.

TABLE 8
Concrete composition I

| Component | | % w/w |
|---|---|---|
| Cementitious agent | Structural cement | 26.53 |
| Fine materials | C90 | 13.1 |
| polydisperse matrix | Sand (N2) | 59.41 |
| Plasticizer | Sika viscocrete | 0.06 |
| Concrete accelerator | Sigunit 49AF Mod/Sigunit 49AF | 0.06/0.04 |
| Rheology controller | Ultragel A | 0.03 |
| Retarder concrete | Plastiment | 0.12 |

* For the characterization of the concrete compositions 13.20% water was added.
** Rosin-Rammler distribution parameter 0.74.

The following compositions include the shrinkage controller as an optional component:

TABLE 9
Concrete composition J

| Component | | % w/w |
|---|---|---|
| Cementitious agent | Structural cement | 26.50 |
| Fine materials | C90 | 13.14 |
| polydisperse matrix | Sand (N2) | 59.40 |
| Plasticizer | Sika viscocrete | 0.06 |
| Concrete accelerator | Sigunit 49AF Mod/Sigunit 49AF | 0.1/0.6 |
| Rheology controller | Ultragel A | 0.04 |
| Retarder concrete | Plastiment | 0.12 |
| Concrete shrinkage controller | Sika Fiber | 0.040 |

* For the characterization of the concrete compositions 13.00% water was added.
** Rosin-Rammler distribution parameter 0.74.

TABLE 10
Concrete composition K

| Component | | % w/w |
|---|---|---|
| Cementitious agent | Structural cement | 26.50 |
| Fine materials | C90 | 13.12 |
| polydisperse matrix | Sand (N2) | 59.16 |
| Plasticizer | Sika viscocrete | 0.06 |
| Concrete accelerator | Sigunit 49AF Mod/Sigunit 49AF | 0.07/0.4 |
| Rheology controller | Ultragel A | 0.04 |
| Retarder concrete | Plastiment | 0.12 |
| Concrete shrinkage controller | Intraplast | 0.53 |

* For the characterization of the concrete compositions 13.50% water was added.
** Rosin-Rammler distribution parameter 0.74.

### Example 2: Characterization of Concrete Compositions for 3D Printing

Compositions A to K of Example 1 were characterized according to their density, flow, deformation, open time, and extrudability. The results are shown in Table 11.

TABLE 11
Properties in plastic state and extrudability
for A to K compositions.

| | Properties in plastic state | | | | |
|---|---|---|---|---|---|
| | | | | Open time- | |
| | | | Defor- | flowability | |
| Compo- | Density | Flow | mation | (mm at 40 | |
| sition | (g/cm³) | (mm) | (%) | min) | Extrudability |
| A | 2.1 | 178 | 8 | 150 | Excellent |
| B | 1.98 | 176 | 4 | 142 | Low/Filter/separate |
| | | | | | phases |
| C | 2.1 | 180 | 7.70 | 159 | Excellent |
| D | 2 | 185 | 20 | 140 | Rough surface/easy |
| | | | | | extrudability/high |
| | | | | | deformability |
| E | 2.1 | 175 | 15 | 137 | Median extrudability/ |
| | | | | | tendency to exudate |
| F | 2 | 175 | 14 | 140 | Medium extrudability/ |
| | | | | | low stackability |
| H | 2.15 | 165 | 11 | 150.75 | Excellent |
| I | 2.15 | 169 | 11 | 139.73 | Good |
| J | 2.1 | 180 | 11 | 147.16 | Excellent |
| K | 2.14 | 169 | 9 | 135 | Good |

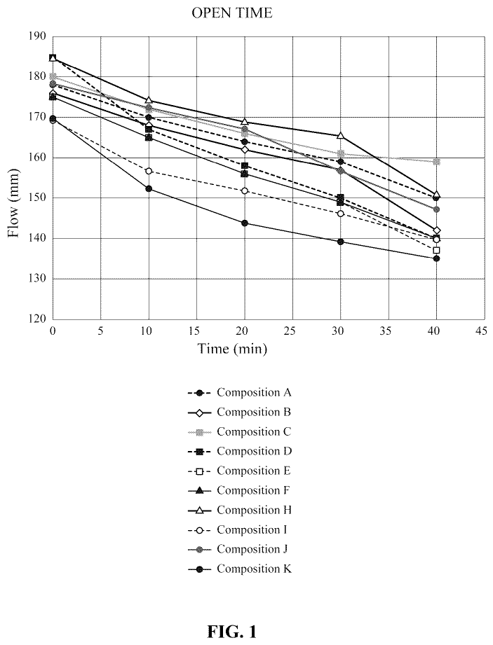

The open time (flowability) behavior for compositions A to K is shown in FIG. 1. In which compositions A, C, H, and J have a longer workability time after 40 minutes compared to compositions B, D, E, and F, i.e., it allows a longer pumpability time, ensuring adhesion between layers because it retains its properties in a plastic state. In contrast, even although compositions I and K show good extrudability behavior, they still do not present the expected optimum behavior compared to compositions A, C, H, and J.

### Example 3: Yield Stress and Compressive Strength

The yield stress values of compositions A, B and C are shown in FIG. 2. This value manages to identify the potential use in pumping processes. In this case, literature has referenced good pumpability when the yield stress values are less than 1500 Pa. Compositions A and C exhibit suitable properties in the plastic state and perform well in the pumping process. In contrast, composition B requires higher stresses to ensure proper pumpability.

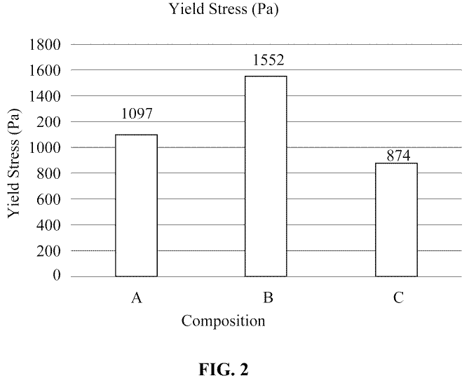

In addition, the compressive strength of the ink is shown in FIG. 3. The ink design seeks to meet the mechanical requirement of 35 MPa, which is relevant because it allows to establish the pumpability of the mixture.

### Example 4: Evaluation of the Percentage of Cracking by Standard Test Method for Evaluating Plastic Shrinkage Cracking of Restrained Fiber Reinforced Concrete ASTMC 1579-2

The tests carried out on structural elements printed with compositions H and J show that the addition of fiber-type plastic shrinkage controllers such as those used in Composition J allows for a 48.98% reduction in cracking in large printed structures compared to the same structures printed with compositions without the addition of shrinkage controllers (Table 12).

TABLE 12
Percentage of cracking by ASTMC 1579-21

| | Average | Total | Surface | Percentage |
|---|---|---|---|---|
| | cracking width | cracking area | area | of cracking |
| Composition | (cm) | (cm²) | (cm²) | (%) |
| H | 0.12 | 8.6 | 1765.5 | 49% |
| J | 0.05 | 4.4 | 1765.5 | 25% |

### Example 5: Applications

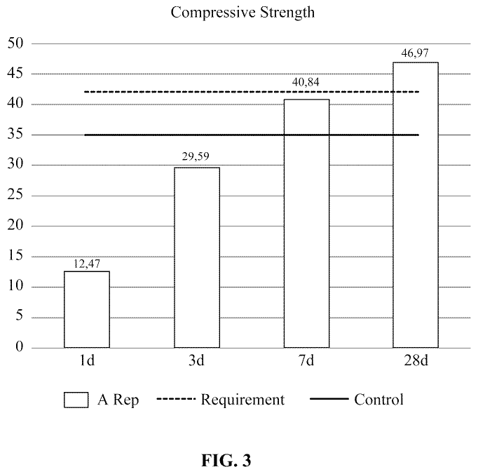

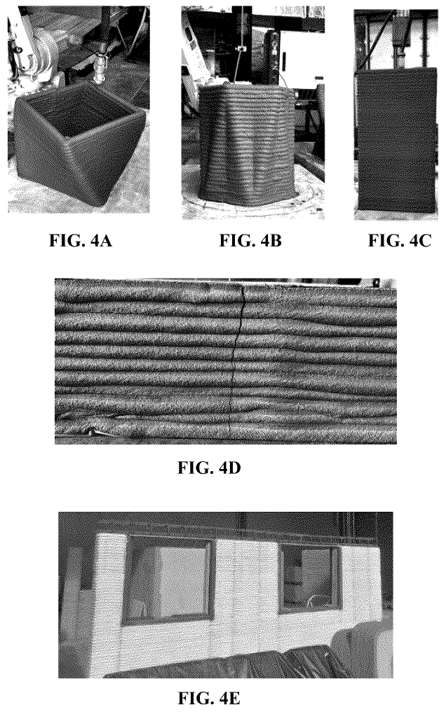

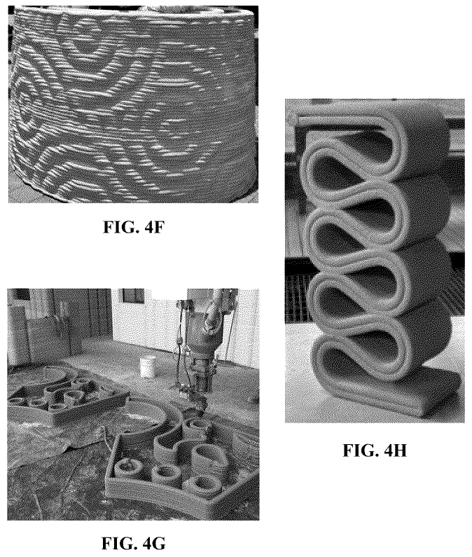

The concrete compositions were used to 3D print three different structures as those in FIG. 4A, FIG. 4B, and FIG. 4C those structures were made by using robot arm. Different shapes can be achieved while maintaining the integrity of the structure and with smooth and homogeneous finishes.

FIGS. 4A and 4B showcase structures printed with composition A using a robotic arm, reaching a maximum height of 38 cm. FIG. 4C, also created with composition A, measures 1 m×0.8 μm and was produced with a small-configured gantry.

FIG. 4E, printed with composition J, represents a model house covering 61 m² and was produced using an industrial gantry. The printability properties, texture, and finishes of the composition were evaluated at a larger scale.

FIG. 4D, printed with composition A using an industrial gantry, has dimensions of 3 m×0.3 m. Continuous cracks are observed, likely due to the scale of the designs and the type of mixture used, while ensuring both stackability and printability of the element, in contrast, FIG. 4E shows a complete structural wall printed with composition J where no cracking is observed.

The printed structures of FIG. 4 demonstrate that the compositions of the present development make it possible to fabricate structural walls, continuous constructions, furniture, and other architectural elements.

FIG. 4F shows the print of a textured column structure, produced using the gantry system. The material exhibited excellent plastic and mechanical performance and provides a high-quality final finish.

FIG. 4G illustrates the ink's adaptability to variations in nozzle specifications. The material maintains consistent performance in both plasticity and mechanical properties, ensuring reliable extrusion and structural integrity even with adjustments to the nozzle configuration.

FIG. 4H presents a component printed with a robotic arm, showcasing a smooth and precise finish. The element, with dimensions of 80 cm×60 cm, demonstrates excellent surface quality and geometric accuracy, highlighting the versatility and precision achievable in smaller-scale 3D printing applications.

1. A concrete composition for 3D printing comprising:
cementitious agent between 20% w/w to 40% w/w;
polydisperse matrix between 50% w/w to 70% w/w;
fine materials between 0% w/w to 20% w/w;
plasticizer between 0.05% w/w to 3% w/w;
concrete accelerator between 0.5% w/w to 9% w/w;
rheology controller between 0.04% w/w to 0.3% w/w;
concrete retarder between 0.1% w/w to 3% w/w;
wherein the cementitious agent has an addition between 0% and 10%; and
wherein the mixture between the cementitious, polydisperse matrix, fine materials have a Rosin-Rammler distribution parameter of less than 1.

2. The concrete composition for 3D printing according to claim 1, wherein the polydisperse matrix is selected from calcareous aggregates, siliceous aggregates, recycled aggregates, and mixtures thereof.

3. The concrete composition for 3D printing according to claim 1, wherein the particle size of the polydisperse matrix is between 0.1 mm and 12 mm.

4. The concrete composition for 3D printing according to claim 1, wherein the particle sizes of the polydisperse matrix are preferably between 0.1 mm and 4 mm.

5. The concrete composition for 3D printing according to claim 1, wherein the fine material is selected from carbonate-based materials including calcium carbonate, silica fume, ash, slag, and mixtures thereof.

6. The concrete composition for 3D printing according to claim 1, wherein the particle size of the fine materials is between 1 μm to 150 μm.

7. The concrete composition for 3D printing according to claim 1, wherein the plasticizer is selected from polycarboxylate, lignosulfonates, naphthalene, melanins, and mixtures thereof.

8. The concrete composition for 3D printing according to claim 1, wherein concrete accelerator is selected from aluminum sulfate, organic and inorganic salts such as oxides, chlorides, bromides, fluorides, nitrites and nitrates, carbonates, thiocyanates, sulfates, thiosulfates, perchlorates, silicates, aluminates, aluminum sulfate and mixtures thereof.

9. The concrete composition for 3D printing according to claim 1, wherein the concrete retarder is selected from polysaccharides or glycols and mixtures thereof.

10. The concrete composition for 3D printing according to claim 1, wherein the rheology controller is selected from medium molecular weight cellulose, cellulose ether, hydroxymethylethylcellulose (HEMC), hydroxypropyl methylcellulose (HPMC), and mixtures thereof.

11. The concrete composition for 3D printing according to claim 1, wherein optionally supplementary cementitious materials (SCMs) are added.

12. The concrete composition for 3D printing according to claim 11, wherein the supplementary cementitious materials (SCMs) are between 5% w/w to 20% w/w.

13. The concrete composition for 3D printing according to claim 11, wherein the particle size of the SCMs is between 1 μm to 150 μm.

14. The concrete composition for 3D printing according to claim 1, wherein the cementitious agent does not have an addition of more than 5%.

15. The concrete composition for 3D printing according to claim 1, wherein optionally concrete shrinkage controllers are added between 0% to 1% w/w.

16. The concrete composition for 3D printing according to claim 15, wherein the concrete shrinkage controllers are polypropylene fibers with a size between 6 mm to 19 mm.

17. A method for using a concrete composition for 3D printing comprising:
a) preparing a concrete composition for 3D printing comprising: a cementitious agent between 20% w/w to 40% w/w; polydisperse matrix between 50% w/w to 70% w/w; fine materials between 0% w/w to 20% w/w; at least one plasticizer between 0.05% w/w to 3% w/w; at least one concrete accelerator between 0.5% w/w to 9% w/w; rheology controller between 0.04% w/w to 0.3% w/w; and concrete retarder between 0.1% w/w to 3% w/w, with water;
wherein the cementitious agent has an addition between 0% and 10%; and
wherein the mixture between the cementitious, polydisperse matrix, fine materials have a Rosin-Rammler distribution parameter of less than 1;
b) filling the pump system with the concrete composition; and
c) pumping said composition through the printer nozzle.

18. The method according to claim 17, wherein optionally concrete shrinkage controllers are added between 0% to 1% w/w when preparing the concrete composition.
